(19) United States
(12) Patent Application Publication
(10) Pub. No.: US 2007/0056693 A1
(43) Pub. Date: Mar. 15, 2007

(54) Advertising method and apparatus therefore

(76) Inventor: Larry L. Szebeni, Rocky Hill, CT (US)

Correspondence Address: MCCORMICK, PAULDING & HUBER LLP, CITY PLACE II, 185 ASYLUM STREET, HARTFORD, CT, 06103, US

(21) Appl. No.: 11/518,812

(22) Filed: Sep. 11, 2006

Related U.S. Application Data
(60) Provisional application No. 60/716,352, filed on Sep. 12, 2005.

(51) Int. Cl. E06B 9/36

(52) U.S. Cl. 160/168.1 V

(57) ABSTRACT

A system for displaying segments of a graphic image in a window or the like, and comprising a plurality of vertically elongated transparent slats, each slat having marginal edges defining inwardly one facing elongated grooves for framing the elongating segments of the graphic image, top and bottom horizontal rails for supporting top and bottom end portions respectively of said slats for rotation on horizontally spaced vertical pivot axes, and means for pivoting said slats in synchronized relationship to each other on vertical slat axes that are spaced along said rails by a dimension W, that is at least approximately equal to the lateral width of said elongated graphic image segments.

This invention relates generally to an apparatus for displaying advertising material in an attention getting manner, and deals more particularly with a method of advertising incorporating such apparatus.

### SUMMARY OF THE INVENTION

The apparatus of the present invention provides a graphic image in a window or the like, the image being presented in segments cut from a printed or otherwise produced image, on a substrate medium which may be transparent or opaque. A plurality of vertically elongated slats are provided for pivotal movement, in unison with one another, the end portions being provided in top and bottom horizontal rails for this purpose. Each slat has marginal edges defining front facing elongated grooves for framing the elongated graphic image segments. An important aspect of the present invention is that slats are designed to overlap slightly, but the images on the segments are provided in closely enough spaced relationship to one another so as to present a uniform image to the viewer. Thus, the axis of rotation of each slat is spaced along the rail by a dimension (w) that is at least approximately equal to the width of each graphic image segment. In the closed positions the marginal edges of the slats overlap each other so the slats, and associated graphic image segments, are provided at on small angle relative to the rails.

A further feature of the present invention is to provide, in each slat, the capability of supporting another image at the backside thereof. Thus, the same or a different image can be presented to persons looking at the window or other opening from either inside or outside a building.

### BRIEF DESCRIPTION OF THE DRAWINGS

FIG. 1 shows a graphic image printed on a substrate in accordance with the first step in the method of the present invention.

FIG. 2 shows the image of FIG. 1 cut into elongated segments in accordance with the present invention.

FIG. 3 shows a slat in accordance with the preferred embodiment of the present invention having the capability of supporting graphic image segments on both the front and rear face thereof.

FIG. 4 shows the graphic image segments provided in a plurality of side-by-side slats, the slats being mounted in the upper and lower horizontally extending rails, and being movable in unison with one another by a socket tool, activating the transmition chain provided at the right hand side of the assembly. The socket tool and transmition chain can be replaced by other controls for rotating a longitudinally extending shaft in each of these rails that is geared to each of the posts that support each of the individual slats.

FIG. 5 shows the apparatus at FIG. 4, but with the slats in the closed position.

FIGS. 6A, B, and C show sections of the side and lower rail, and illustrate a preferred structure for supporting the side-by-side slats, and for moving these slats.

FIG. 7 is a horizontal section and shows the rail of FIG. 6, fitted with side-by-side slats, the slats being shown in the closed position.

FIG. 8 is a view similar to FIG. 3, but showing a slat having images mounted both in the front and rear face thereof.

### DETAILED DESCRIPTION

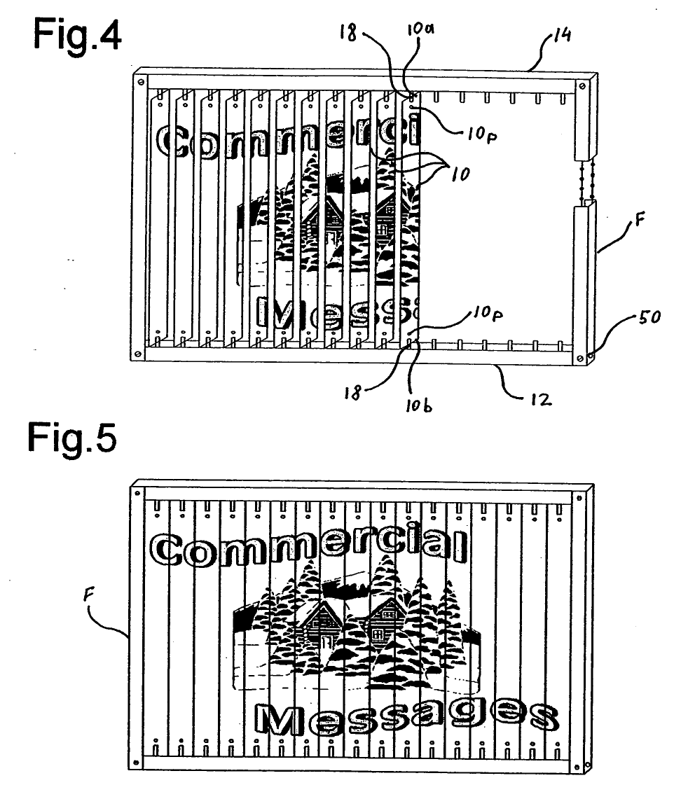

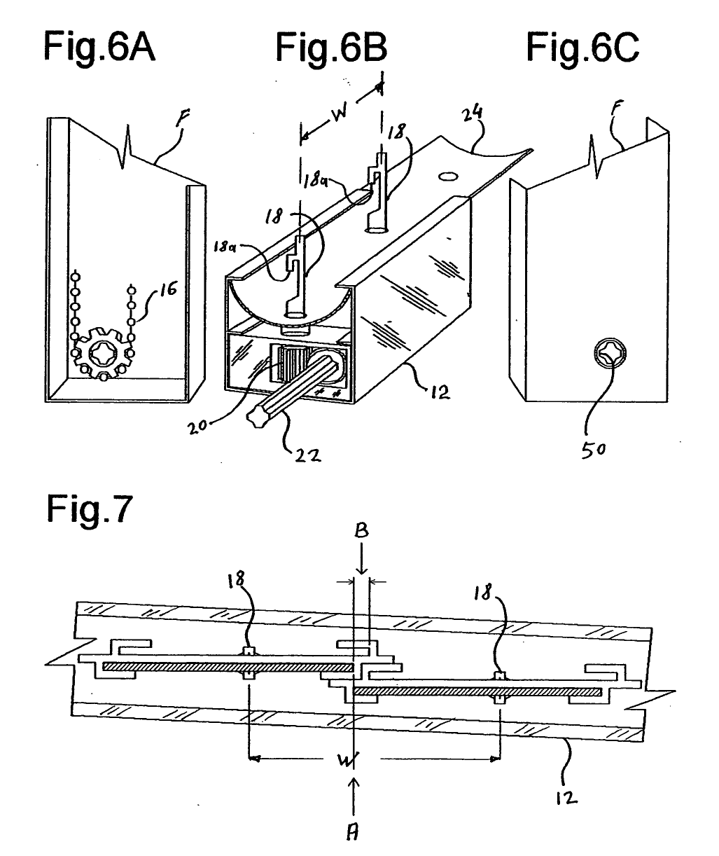

Turning first to FIG. 4, a display system or apparatus of the present invention is illustrated as comprising as plurality of vertically oriented slats 10,10 each slat having upper and lower end portions 10a and 10b provided on posts 18 to be described. A frame includes lower and upper rails 12 and 14. Each post is adapted to support a slat as shown in FIG. 6B, and is provided with pinions 20 that are engaged by longitudinal extending shafts 22 so that rotation of these shafts by the transmition chain 16 causes rotation of the longitudinal shafts, and results in synchronized rotation of the posts to move the slats between the position shown for them in FIG. 4 and that shown in FIG. 5 for example.

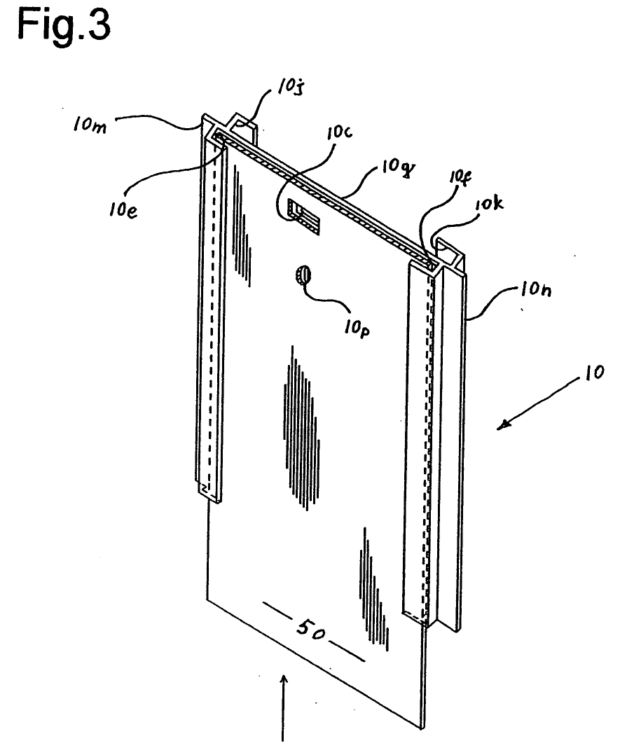

FIG. 6 shows a segment of the lower rail assembly, and illustrates two posts 18, 18, of the type adapted to retrieve slats, such as the slat indicated in FIG. 3. Each slat has an opening 10c for receiving a tang 18a provided in a slotted opening at the upper end of the post 18 in order to secure each slat to its associated post. A second opening 10p provided to hold each graphic segment in slat 10 with a pin (not shown). As mention previously the elongated shaft 22 provided in each of the upper and lower rails, and the transmition chain 16 are designed for opening and closing the pivotably mounted slats provided in the frame F. In addition, the top and bottom rails 12 and 14, this frame includes inwardly open side channels best shown in FIGS. 5, 6 and 7.

An important feature of the present invention can be traced to the fact that the spacing between the posts 18, indicated generally at W in FIG. 6, corresponds closely to the inside dimension of the receptacle provided in the slat 10 which receives the segment of the graphic image. This dimension W therefore defines the width of each of these graphic image segments. This geometry provides a continuous graphic image when the slats are dosed as suggested in FIG. 7.

FIG. 6A shows a channel shaped side rail suitably shaped for hiding transmition chain 16 (to prevent unauthorized moving of the slats).

FIGS. 6A, B and C also shows how access to move transmition chain 16 is only possible by inserting a tool (not shown) in to socket 50 for moving there slats.

In its presently preferred form each of the slats 10, has marginal edges defining a front facing and a rear facing stat frame. Each slat frame defines grooves for receiving in the marginal edges of the slats, as best shown in FIG. 3. The graphic image segment shown in FIG. 3 at 50 has a width W corresponding to the spacing W between the posts as described above with reference to FIGS. 6 and 7. The slat 10 is preferably extruded from a translucent material, and has marginal edges with inwardly opening grooves to receive the marginal edges of the slats. Inwardly facing grooves 10e and 10f are provided on the front side of the slat 10, and defined by the L-shaped projections along each edge in conjunction with the central web portion 10g of the slat.

It is a further feature of the present invention that the backside of the slat 10 also includes L-shaped projections that define inwardly facing grooves 10j and 10k for receiving additional substrate segments to be described.

It is an important feature of the present invention that each of the slats 10, 10 includes laterally projecting extension of the web portion 10g (illustrated at 10m and 10n) these extensions are so designed that adjacent slats abut one another to determine the dosed position for all of the slats, as best shown in FIG. 7.

Thus the slat 10 illustrated in FIG. 3 is intended for supporting a single substrate segment 50 at the front side of each slat so as to present the desired graphic image to a person from one side of the display system. The slat 10 further includes a backside that is similarly configured, but offset slightly from the front side, to receive segments that might be used to display a different or the same image to persons on the other side of the display system. FIG. 7 shows why this offset is necessary, the reason being that the slats, when dosed, are oriented parallel to one another, but at a shallow angle to the longitudinal center-line of the rail 12., eliminating any gap between the graphic image segments in the dosed position. In FIG. 7 the arrow A indicates the viewing angle of an observer on the one side of the display system where as the arrow B indicates the angle of the observers view point from the opposite side of the display system. The offset itself is illustrated in FIG. 7 at x. Thus, not only do the slats 10 overlap one another as shown in FIG. 7, but also, the graphic image segments provided at the front and rear of each slat are angled with respect to the rail 12.

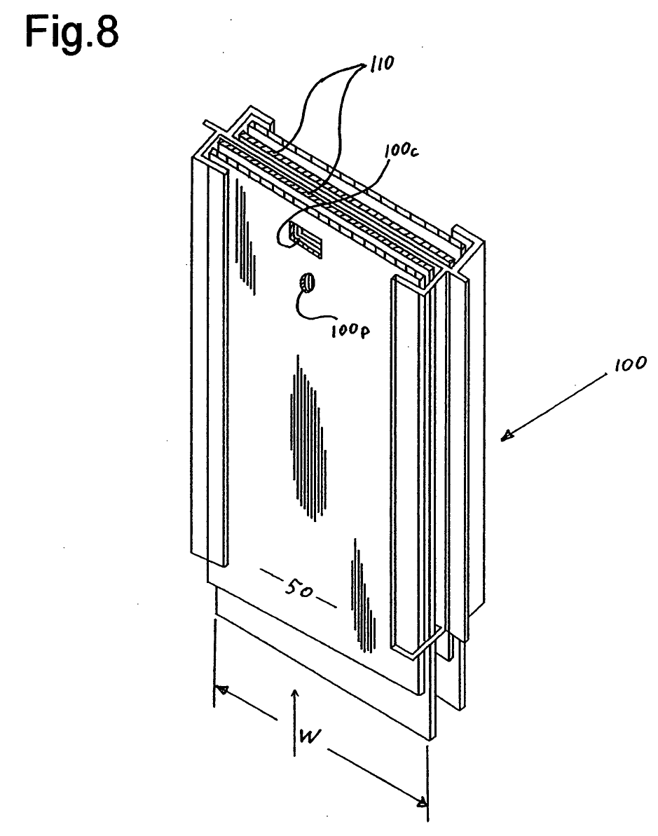

FIG. 8 shows a slat 100 generally similar to the slat 10, but having a slightly greater overall thickness to accommodate not only the substrate image 50 itself but to also accommodate a “flat light” strip 110. Such a “flat light” strip 110 may be placed in the both front and back of the slat 100 in order to provide illumination to the display on both the front and rear sides thereof. These “flat light” materials are of a type adapted to generate light in response to an electric current. The electroluminescent nature of the material of these “flat light” strips illuminated the image both front and back of the display system of the present invention.

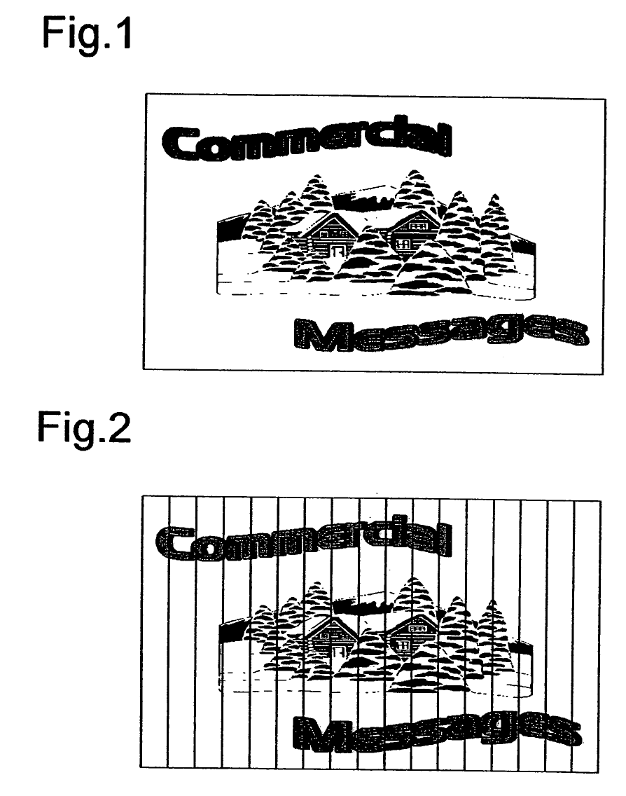

It is nevertheless a feature of the present invention that even in the absence of such luminous, back lighting, the interior lights of a building afford a “light box effect” on a single image provided on the transparent/translucent slats 10 of FIGS. 1-7.

While the above described display system can be adapted and used for presenting a scenic picture as illustrated by the image of FIG. 1 above, it is also the case that a commercial advertising message can also be displayed in a system of the present invention. Furthermore, simply by removing each of the image segments in turn and replacing them with segments cut from a different substrate or image one can change the display. The preferred material for these images is a fade and tear resistant material, which lends itself to easy removable and replacement, a decided advantage when the owner of the display system of the present invention leases or otherwise rents the display to the proprietor of a business for advertising purposes.

In its presently preferred form the method of present invention entails printing a graphic image on a substrate, preferably a translucent media, followed by cutting the substrate into elongated graphic segments of width “W”. These graphic segments are then inserted into the generally rectangular transparent polymeric extruded slat frames, both front and rear if desired, and the slat frames are mounted on the upper and lower posts provided in the upper and lower rails. The openings in the image segments and slat frames will hold each slat assembly in position for removal and replacement at the end of the agreed to rental period or term. Each of the slats is formed with precisely profiled marginal edges that are designed to allow these slats to overlap, but which are also designed to present to the viewer the graphic segments in accurately indexed relationship to one another so as to avoid any gaps in the resulting image as,seen by the observer. Vertical alignment between adjacent image segments is achieved by an elongated locating strip 24, which is provided for this purpose in the channel shaped rail 12. A similar strip is provided in the upper rail 14. Each strip 24 is resiliently deformable and exerts a spring force on the end portions of the slats to achieve retention of these graphic image segments in relationship to one another.

In light of the above it is therefore understood that within the scope of the appended claims, the invention may be practiced otherwise in as specifically described.

What is claimed:

1. A system for displaying a segmented graphic image in a window or the like, and comprising:
a) a plurality of vertically elongated transparent slats, each slat having marginal edges defining inwardly facing elongated grooves for framing the segments of the graphic image,
b) top and bottom horizontal rails for supporting top and bottom end portions respectively of said slats for rotation on horizontally spaced vertical pivot axes, and
c) means for pivoting said slats in synchronized relationship to each other on said vertical slat axes that are spaced along said rails by a dimension (W), that is at least approximately equal to the lateral width of said elongated graphic image segments.

2. The system according to claim 1 wherein said slats have inter-fitting marginal edges that overlap one another in a manner that allows said graphic image segments to abut one another visually in a dosed position, said slats presenting said image segments to the viewer in a non planar fashion as a result of the slats being oriented at a slight angle with respect to the rails when moved to said closed positions, wherein the marginal edges are nested together.

3. The system according to claim 2 further characterized by a second pair of inwardly facing elongated groves in said slats for framing elongated segments of another graphic image for display at the opposite side of said slats.

4. The system according to claim 3 further characterized by electroluminescent panels provided between said first and second graphic image segments.

5. The system according to claim 1 further characterized by the interior light of a building providing a “light box” effect on a single image provided on the transparent/translucent slats.

6. A method for displaying an image for view at day and night in a window or the like, said method comprising the steps of:
a) providing an image on a substrate, slicing the substrate into vertically elongated segments,
b) providing a plurality of vertically elongated slats with grooves for receiving the vertically elongated graphic image segments,
c) providing for rotation of these slats from and to a closed position that displays the segments to an observer on at least one side of the closed slats.

7. The method of claim 6, further including the business method steps of:
a) soliciting customers for periodic payments to display an image selected by the customer from design proposals prepared by the business,
b) installing the image in a place or places selected by the customer;
c) renewing the periodic payment arrangement of step a) above in return for renewal by that business.
